(19) United States
(12) Patent Application Publication
(10) Pub. No.: US 2020/0290346 A1
(43) Pub. Date: Sep. 17, 2020

(54) EJECTION APPARATUS, EJECTION METHOD, ARTICLE MANUFACTURING APPARATUS, AND STORAGE MEDIUM

(71) Applicant: CANON KABUSHIKI KAISHA, Tokyo (JP)

(72) Inventors: Ken Katsuta, Saitama-shi (JP); Hisashi Namba, Utsunomiya-shi (JP); Noriyasu Hasegawa, Utsunomiya-shi (JP)

(21) Appl. No.: 16/892,516

(22) Filed: Jun. 4, 2020

Related U.S. Application Data
(63) Continuation of application No. PCT/JP2018/043561, filed on Nov. 27, 2018.

(30) Foreign Application Priority Data
Dec. 19, 2017 (JP) 2017-242784

(51) Int. Cl. B41J 2/045; B41J 2/14

(52) U.S. Cl. CPC B41J 2/04588; B41J 2/04535; B05D 1/26; B41J 2/14201; B41J 2/04581

(57) ABSTRACT

Provided is an ejection apparatus capable of ejecting a fluid appropriately from all nozzles. The ejection apparatus includes: ejection unit having a plurality of nozzles for ejecting a fluid in a liquid state; and control unit configured to control ejection of the fluid from each of the plurality of nozzles by applying a drive signal to an ejection energy generation element included in the nozzle. The control unit has an adjustment table for adjustment of the drive signal for each of the nozzles, and adjusts ejection from each of the nozzles based on an ejection result of the nozzle obtained by obtaining unit and the corresponding adjustment table.

### CROSS-REFERENCE TO RELATED APPLICATIONS

This application is a Continuation of International Patent Application No. PCT/JP2018/043561, filed Nov. 27, 2018, which claims the benefit of Japanese Patent Application No. 2017-242784, filed Dec. 19, 2017, both of which are hereby incorporated by reference herein in their entirety.

### BACKGROUND OF THE INVENTION

### Field of the Invention

The present invention relates to an ejection apparatus that ejects a fluid in a liquid state, an ejection method, an article manufacturing apparatus, and a storage medium.

### Background Art

Recently, ejection apparatuses that eject an ejection material such as a fluid in a liquid state from a plurality of nozzles to perform microfabrication have been used to manufacture semiconductor devices, MEMS, and so on. As such an ejection apparatus, an imprint apparatus has been known which, for example, ejects a fluid in a liquid state such as an uncured resin 114 having relatively high viscosity from nozzles onto a substrate and presses a mold processed to have concavities and convexities against the ejected resin 114 to thereby form a predetermined pattern in the resin 114. The imprint apparatus is capable of forming an article having a fine structure on the order of several nanometers on a substrate.

The ejection apparatus used in an apparatus that performs microfabrication, such as the imprint apparatus, is required to have high accuracy in, for example, ejection speed and ejection volume of the ejection material to be ejected from its nozzles. In a case where the ejection speed of the ejection material from the nozzles deviates from a target value, the ejection material is displaced from the positions on the ejection target object, such as a substrate, to which the ejection material is supposed to adhere. Also, if the ejection volume from the nozzles deviates from a target ejection volume, there is a possibility that the thickness of the applied ejection material will be uneven and the pattern to be formed will not have the desired shape.

Then, in a case where the ejection speed and the ejection volume deviate from the respective target values, it is conceivable to correct the waveform of a drive signal to be inputted into each of ejection energy generation elements (piezoelectric elements) included in the nozzles. Patent Literature 1 discloses a technique in which the waveform of a drive signal to be inputted into each nozzle is corrected based on the ejection speed and the ejection volume of an ejection material ejected from the nozzle as a result of inputting a drive signal with a reference waveform into an ejection energy generation element in the nozzle.

In the technique disclosed in Patent Literature 1, a table indicating a relationship between parameters that determine the waveform of the drive signal and the ejection volume and ejection speed is generated for one representative nozzle selected from among the plurality of nozzles. Then, the ejection speed and the ejection volume of all nozzles are adjusted based on this table. For this reason, in a case where the degree of change in ejection volume and ejection speed (ejection tendency) in response to a change in the parameters greatly varies among nozzles, not all of the nozzle's ejection can be appropriately adjusted.

### CITATION LIST

### Patent Literature

PTL 1: Japanese Patent Laid-Open No. 2012-45780

### SUMMARY OF THE INVENTION

An object of the present invention is to provide an ejection apparatus, an ejection method, and an article manufacturing apparatus capable of ejecting a fluid appropriately from all nozzles.

The present invention provides an ejection apparatus comprising: ejection unit having a plurality of nozzles for ejecting a fluid in a liquid state; control unit configured to control ejection of the fluid from each of the plurality of nozzles by applying a drive signal to an ejection energy generation element included in the nozzle; obtaining unit configured to obtaining an ejection result of the fluid ejected from the nozzle; and storage unit for storing an adjustment table for adjustment of the drive signal for each of the plurality of nozzles, the adjustment table indicating a relationship between waveform information on the drive signal for each of the nozzles and an ejection volume and ejection speed of the fluid ejected from the nozzle, in which the control unit adjusts ejection from each of the nozzles based on the corresponding adjustment table and the corresponding ejection result obtained by the obtaining unit.

Also, the present invention provides an ejection method of ejecting a fluid in a liquid state from each of a plurality of nozzles for ejecting the fluid by applying a drive signal to an ejection energy generation element included in the nozzle, characterized in that the ejection method comprises: preparing an adjustment table for adjustment of the drive signal for each of the nozzles; obtaining an ejection result of the fluid ejected from the nozzle; storing the adjustment table for adjustment of the drive signal for each of the plurality of nozzles, the adjustment table indicating a relationship between waveform information on the drive signal for each of the nozzles and an ejection volume and ejection speed of the fluid ejected from the nozzle; and adjusting ejection from each of the nozzles based on the corresponding adjustment table and the corresponding ejection result obtained by the obtaining.

Also, the present invention provides an article manufacturing apparatus that ejects a fluid in a liquid state onto a predetermined ejection target object from a plurality of nozzles provided in ejection unit, and pressing a mold against the fluid ejected onto the ejection target object to thereby form a pattern in the fluid, characterized in that the article manufacturing apparatus comprises: control unit configured to control ejection of the fluid from each of the plurality of nozzles by applying a drive signal to an ejection energy generation element included in the nozzle; obtaining unit configured to obtain an ejection result of the fluid ejected from the nozzle; and storage unit configured to store an adjustment table for adjustment of the drive signal for each of the plurality of nozzles, the adjustment table indicating a relationship between waveform information on the drive signal for each of the nozzles and an ejection volume and ejection speed of the fluid ejected from the nozzle, in which the control unit adjusts ejection from each of the nozzles based on the corresponding adjustment table and the corresponding ejection result obtained by the obtaining unit.

Further features of the present invention will become apparent from the following description of an exemplary embodiment to be given with reference to the attached drawings.

### BRIEF DESCRIPTION OF THE DRAWINGS

FIG. 1 is a front view schematically showing an entire configuration of an article manufacturing apparatus in an embodiment;

FIG. 2A is a conceptual diagram showing a process of ejection of a droplet from a nozzle, and shows a state before a piezoelectric element in the nozzle is driven;

FIG. 2B is a conceptual diagram showing the process of ejection of a droplet from the nozzle, and shows a state where a resin is pulled in inside the nozzle as a result of driving the piezoelectric element;

FIG. 2C is a conceptual diagram showing the process of ejection of a droplet from the nozzle, and shows a state immediately after a droplet is ejected from the nozzle as a result of driving the piezoelectric element;

FIG. 3 is a diagram showing the waveform of a drive signal to be applied to a nozzle, and the surface position of a fluid inside the nozzle;

FIG. 4A is a diagram showing a first parameter of the drive signal;

FIG. 4B is a diagram showing a second parameter of the drive signal;

FIG. 5 is a diagram showing a first adjustment table for the drive signal;

FIG. 6 is a diagram showing the first adjustment table and a second adjustment table obtained by correcting the first adjustment table; and

FIG. 7 is a flowchart showing a process of adjusting the ejection volume from each nozzle.

### DESCRIPTION OF THE EMBODIMENTS

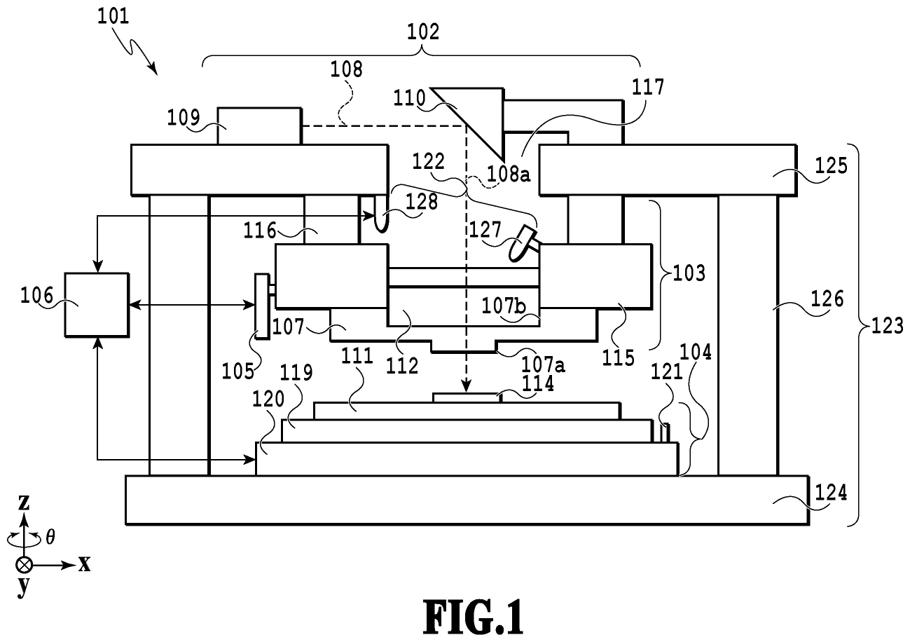

An embodiment of the present invention will be described below in detail with reference to the drawings. FIG. 1 is a front view schematically showing an entire configuration of an imprint apparatus as an article manufacturing apparatus.

An imprint apparatus 101 mainly performs an imprint process as below. Firstly, an uncured resin (a fluid in a liquid state) 114 is ejected onto a surface (upper surface in the view) of a substrate 111, which is an ejection target object. Then, a mold on which is formed a pattern having a concavo-convex shape is pressed against the uncured resin 114 ejected onto the surface of the substrate 111. Then, after the resin 114 reaches a cured state, the mold is separated (released) from the resin. By the imprint process including the above steps, an article is obtained which has a three-dimensional pattern following the pattern on the mold.

Such an imprint process is capable of forming an article having an extremely fine pattern on the order of nanometers, and is preferably used in manufacturing of semiconductor devices and the like. Note that in the present embodiment, an imprint apparatus employing a photo-curing method, in which the resin 114 with a pattern formed therein is cured by being irradiated with light, is presented as an example. However, the present invention is also applicable to imprint apparatuses using other techniques, e.g., an imprint apparatus using a thermosetting method, in which the resin is cured by heat.

The imprint apparatus 101 includes a light application unit 102, a mold holding mechanism 103 holding the mold 107, a substrate stage 104, an ejection unit 105, obtaining unit 122, a control unit 106, a housing 123, and so on. Also, in the apparatus shown, a Z axis is set in parallel to an optical axis 108a of an ultraviolet ray 108 to be applied to the resin 114 ejected onto the substrate 111, and an X axis and a Y axis perpendicular to each other are set in a plane perpendicular to the Z axis.

The housing 123 includes a base surface plate 124 holding the later-described substrate stage 104, a bridge surface plate 125 holding the mold holding mechanism 103 and the light application unit 102, and columns 126 supporting the bridge surface plate 125. The columns 126 are provided upright on the base surface plate 124.

The substrate stage 104 has the function of a movement mechanism that holds the substrate 111 to which the resin 114 to be subjected to an imprint process is to be applied and moves the substrate 111 along the plane defined by the X axis and the Y axis (XY plane). By moving the substrate 111 along the XY plane by unit of this substrate stage 104, the substrate 111 and the ejection unit 105 are positioned relative to each other in the XY plane and the resin 114 ejected onto the surface of the substrate 111 and the mold 107 are positioned relative to each other in the XY plane.

The substrate stage 104 has a substrate chuck 119 that holds the substrate 111 by vacuum suction, and a substrate stage housing 120 that holds the substrate chuck 119 and moves it in the XY plane with mechanical unit. Further, the substrate stage 104 is provided with a stage reference mark 121 to be utilized to determine the positions of the surface of the substrate chuck 119 and the mold 107, which is located above the substrate chuck 119, relative to each other in the XY plane.

The substrate stage housing 120 is provided with an actuator for moving the substrate chuck 119. A linear motor that moves the substrate chuck 119 in the X axis direction and the Y axis direction, for example, can be employed as the actuator. Also, the substrate stage housing 120 may include a plurality of drive systems such as an X- and Y-axis coarse movement drive system and an X- and Y-axis fine movement drive system. Further, the substrate stage housing 120 may be provided with a drive system for correcting the position of the substrate chuck 119 in the Z axis direction, and a configuration having a function to correct the position of the substrate chuck 119 in a direction θ, a tilt function to correct the inclination of the substrate chuck 119, and so on.

The substrate 111 is, for example, a monocrystalline silicon substrate or an SOI (Silicon On Insulator) substrate, onto a surface of which the curable resin 114 to be shaped by a pattern portion 107a formed on the above-mentioned mold 107 is ejected from the later-described ejection unit 105. Note that an ultraviolet curable resin 114, which cures by being irradiated with an ultraviolet ray, is used as the curable resin 114 in the present embodiment.

The light application unit 102 is held on the bridge surface plate 125 and, in an imprint process, applies light with a predetermined wavelength, e.g., the ultraviolet ray 108, to the mold 107. This light application unit 102 includes a light source 109 and an optical element 110 that corrects the direction and position of the ultraviolet ray 108 emitted from this light source 109 to an appropriate direction and position relative to the resin 114 ejected onto the substrate 111. Note that the light application unit 102 is installed since a photo-curing method is employed in the present embodiment. In a case where a thermosetting method is employed, for example, a heat source unit that cures a thermosetting resin 114 may be installed in place of the light application unit 102.

The mold 107 includes the pattern portion 107a, which, in an example, has a rectangular outer periphery and a three-dimensional shape for transferring a concavo-convex pattern such as a circuit pattern into the resin 114 ejected onto the substrate 111. Meanwhile, the mold 107 is made of a material capable of transmitting the ultraviolet ray 108, such as quartz. Further, the mold 107 may be shaped such that its surface to be irradiated with the ultraviolet ray 108 has a cavity 107b formed in a recessed shape in order to facilitate deformation of the mold 107. This cavity 107b has a circular and planar shape, and its depth is set as appropriate according to the size and material of the mold 107.

The mold holding mechanism 103 has a mold chuck 115 that holds the mold 107 by attracting it with vacuum suction force or electrostatic force, and a mold drive mechanism 116 that moves the mold chuck 115 in the Z axis direction. The mold drive mechanism 116 moves the mold chuck 115 holding the mold 107 in the Z axis direction so as to selectively perform pressing or separation (release) of the mold 107 against or from the resin 114 on the substrate 111. Examples of actuators employable for this mold drive mechanism 116 include a linear motor, an air cylinder, and so on. Also, for accurate positioning of the mold 107, the mold drive mechanism 116 may include a plurality of drive systems such as a coarse movement drive system and a fine movement drive system. Further, a configuration may be employed which has a function to correct not only the position in the Z axis direction but also the positions in the X axis direction and the Y axis direction or the position in the direction θ, which represents rotation about the Z axis, a tilt function to correct the inclination of the mold 107, and the like. Note that the operation of pressing and separating the mold 107 against and from the resin 114 ejected onto the substrate 111 may be implemented by moving the mold chuck 115 in the Z axis direction, as described above, but may be implemented by moving the substrate stage 104 in the Z axis direction or by moving both the mold chuck 115 and the substrate stage 104 relative to each other.

An opening region 117 is formed through center portions of the mold chuck 115 and the mold drive mechanism 116 so that the ultraviolet ray 108 emitted from the light source 109 of the light application unit 102 can be applied to the substrate 111 via the optical element 110.

Also, the configuration can be such that in the opening region 117, which is formed in the above-mentioned mold holding mechanism 103, an optically transmissive member 113 that forms a closed space 112 is installed and the pressure inside the space 112 is controlled by a pressure correction apparatus. With this configuration, in an example, the pressure correction apparatus raises the pressure inside the space 112 to above the pressure of the outside space in a case where the mold 107 is pressed against the resin 114 ejected onto the substrate 111, for example. By raising the pressure inside the space 112, the pattern portion 107a bends to arch toward the substrate 111 and comes into contact with the resin 114 from a center portion of the pattern portion 107a. In this manner, it is possible to prevent entrapment of a gas (air) between the pattern portion 107a and the resin 114 and thus fill the resin 114 thoroughly in and on the concavities and convexities of the pattern portion 107a.

The ejection unit 105 has a plurality of nozzles that eject the uncured resin 114 into the form of droplets and apply them onto the substrate 111. In the present invention, each nozzle includes a portion forming a region in which an ink is present, and an ejection energy generation element that generates ejection energy for ejecting the ink in the region from an opening portion (ejection opening). The present embodiment employs a method in which a piezoelectric element, which converts electrical energy into mechanical energy, is used as the ejection energy generation element and its piezoelectric effect is utilized to eject the resin 114 from the nozzle. Specifically, the later-described control unit 106 generates a drive signal having a predetermined waveform, and the piezoelectric element is controlled to deform into a shape suitable for ejection by receiving the drive signal. The plurality of nozzles are controlled independently of each other by the control unit 106.

The resin 114 to be ejected from the ejection unit 105 is a photo-curable resin 114 having such properties that it cures by receiving the ultraviolet ray 108, and its material is selected as appropriate according to various conditions in a semiconductor device manufacturing process or the like. Also, the amount of the resin 114 to be ejected into the form of a droplet (hereinafter also referred to as droplet) from each ejection nozzle of the ejection unit 105 is determined as appropriate according to the desired thickness of the resin 114 to be formed on the substrate 111, the density of the pattern to be formed, and so on. This ejection unit 105, the mold drive mechanism 116, and the control unit 106 constitute an ejection apparatus.

The obtaining unit 122 includes an alignment measurement instrument 127 and an observation measurement instrument 128 as representative measurement instruments. The alignment measurement instrument 127 measures misalignment between an alignment mark formed on the substrate 111 and an alignment mark formed on the mold 107 in the X axis direction and the Y axis direction. The observation measurement instrument 128 is an image capturing apparatus such as a CCD camera, for example, and obtains image information of the pattern formed in the resin 114 ejected onto the substrate 111.

The control unit (control unit) 106 is capable of controlling the operations of constituent components of the imprint apparatus 101, correction, and so on. In an example, the control unit 106 is a computer or the like including a CPU, a ROM, and a RAM (storage unit), and the CPU performs various arithmetic processes. The control unit 106 is connected to constituent components of the imprint apparatus 101 through lines and controls the constituent components in accordance with a program stored in the ROM or the like. In an example, the control unit 106 controls the operations of the mold holding mechanism 103, the substrate stage 104, and the ejection unit 105 based on measurement information from the obtaining unit 122. Note that the control unit 106 may be configured integrally with other parts of the imprint apparatus 101 or may be configured as a separate part from the other parts of the imprint apparatus 101. Also, a configuration including a plurality of computers, instead of a single computer, an ASIC, and so on may be employed.

The imprint apparatus 101 further includes a mold conveyance mechanism not shown that conveys the mold 107 from outside the apparatus to the mold holding mechanism 103, and a substrate conveyance mechanism not shown that conveys the substrate 111 from outside the apparatus to the substrate stage 104. The operations of the mold conveyance mechanism and the substrate conveyance mechanism are controlled by the control unit 106.

Next, an imprint process by the imprint apparatus 101 will be described. The control unit 106 controls the substrate conveyance mechanism to place and fix the substrate 111 onto the substrate chuck 119 on the substrate stage 104 and then moves the substrate chuck 119 to an application position for the ejection unit 105. Thereafter, the control unit 106 controls the ejection unit 105 and the substrate stage 104 so as to execute an application step of applying the resin 114 onto the substrate 111.

In the application step, the control unit 106 applies drive signals with waveforms generated according to the ejection tendencies of the plurality of nozzles provided in the ejection unit 105, to the piezoelectric elements provided in the nozzles, respectively. As a result, a droplet of the resin 114 is ejected in the same ejected state from each nozzle. Note that the ejection tendency of a nozzle refers to the degree of change in ejection volume and ejection speed in response to a change in parameters being waveform information that determines the waveform of the drive signal to be applied to the ejection energy generation element provided in the nozzle.

Also, during the ejection operation, the control unit 106 moves the substrate chuck 119 along the XY plane in a direction crossing (usually the direction perpendicular to) the array direction of the nozzles. As a result, the resin 114 is applied onto a pattern formation region being a predetermined processing target region on the substrate 111.

Thereafter, the control unit 106 moves the substrate chuck 119 such that the pattern formation region on the substrate 111 with the resin 114 applied thereto is located directly below the pattern portion 107a formed on the mold 107. The control unit 106 then performs a pressing step of pressing the mold 107 against the resin 114 on the substrate 111 by driving the mold drive mechanism 116. By this pressing step, the resin 114 comes into tight contact with the concavities and convexities of the pattern portion 107a.

In this state, the control unit 106 performs a curing step by driving the light application unit 102. The ultraviolet ray 108 emitted from the light application unit 102 is applied to the upper surface of the mold 107 via the optical element 110 and the optically transmissive member 113. The ultraviolet ray applied to the mold 107 travels through the mold 107, which is optically transmissive, and is applied to the resin 114. As a result, the resin 114 cures.

After the resin 114 cures, the control unit 106 performs a separation step of raising the mold chuck and separating the mold 107 from the resin 114 by driving the mold drive mechanism 116. As a result, on the surface of the pattern formation region on the substrate 111, a pattern of the resin 114 is formed which has a three-dimensional shape following the concavities and convexities of the pattern portion 107a.

By performing a series of imprint operations as above a plurality of times while changing the pattern formation region by driving the substrate stage 104, a plurality of the patterns of the resin 114 can be formed on a single substrate 111.

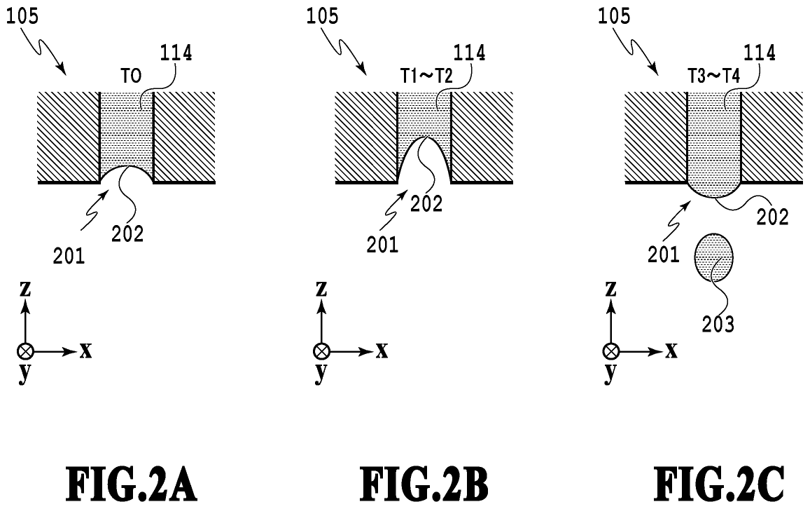

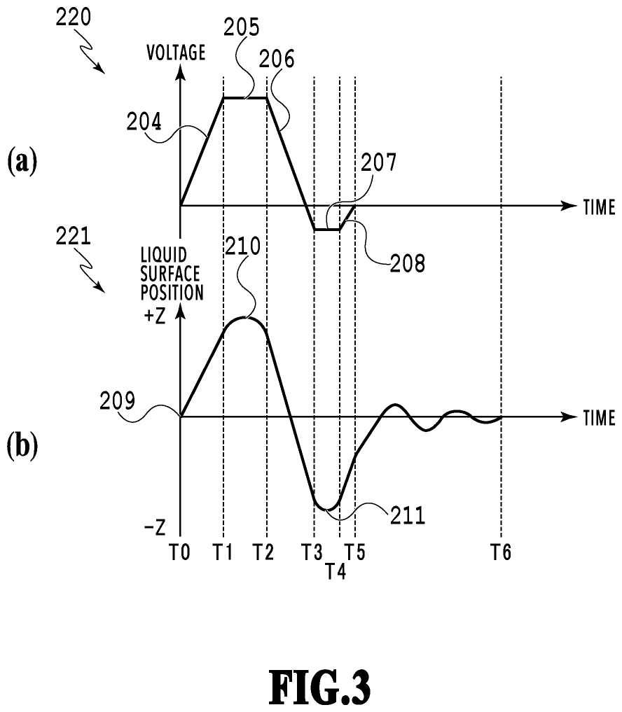

Next, with reference to FIGS. 2 and 3, a process of ejection of a resin droplet 203 from a nozzle 201 will be described along with a drive signal 220 to be applied to the piezoelectric element (ejection energy generation element) included in the nozzle and the liquid surface position of the liquid resin 114 in the nozzle.

FIGS. 2A, 2B, and 2C show a XZ-plane cross section of one nozzle 201 among the plurality of nozzles provided in the ejection unit 105. FIG. 2A shows a state before the piezoelectric element of the nozzle 201 is driven, FIG. 2B shows a state where the resin 114 is pulled in inside the nozzle 201 as a result of driving the piezoelectric element, and FIG. 2C shows a state immediately after a droplet 203 is ejected from the nozzle 201 as a result of driving the piezoelectric element. Note that the X, Y, and Z directions in the diagrams correspond to those in FIG. 1. Also, the interface between the resin 114 in the nozzle 201 and the ambient air is shown as a liquid surface 202, and the ejected resin 114 is shown as the droplet 203.

Part (a) of FIG. 3 shows the waveform of the drive signal 220 to be applied to a piezoelectric element provided in the ejection unit 105. Here, the horizontal axis represents time while the vertical axis represents voltage. The waveform of the drive signal 220 in the present embodiment is trapezoidal, which is the most basic waveform. The drive signal 220 with this trapezoidal waveform is a voltage signal to be applied to the piezoelectric element to eject the resin 114 in the nozzle 201 into the form of the droplet 203, and includes the following five components. Specifically, the drive signal 220 includes five components of a pull component 204, a first hold component 205, a push component 206, and a second hold component 207 and a return component 207 for returning the voltage value to the initial value.

These components of the drive signal 220 correspond to five time sections divided from a time period from T0 to T5. The voltage waveform in the time section from T0 to T1 represents the pull component 204, the voltage waveform in the time section from T1 to T2 represents the first hold component 205, and the voltage waveform in the time section from T2 to T3 represents the push component 206. Further, the voltage waveform in the time section from T3 to T4 represents the second hold component 207, and the voltage waveform in the time section from T4 to T5 represents the return component 208. Note that the time section from T5 to T6 represents the time taken by the liquid surface 202 of the resin 114 in the nozzle 201 to return to the position in the initial state shown in FIG. 2A (a reference position 209 in part (b) of FIG. 3) after the droplet 203 is ejected from the nozzle 201.

Part (b) of FIG. 3 is a diagram showing the liquid surface position in the nozzle 201, and shows the position of the liquid surface 202 in the Z direction. In the initial state before the piezoelectric element included in the nozzle 201 is driven, the liquid surface 202 is at the reference position 209. Then, as the piezoelectric element is driven, the liquid surface 202 is firstly pulled in in the +Z direction to a pulled position 210 and then pushed in the −Z direction to a pushed position 211. The droplet 203 is formed before this pushed position 211 is reached. Thus, the actual position of the liquid surface is on the −Z direction side relative to the position shown in part (b) of FIG. 3. However, for a simple illustration, part (b) of FIG. 3 does not show the position at which the droplet 203 is formed and shows a representative position of the liquid surface 202. Technically, the liquid surface 202 moves after a delay from the time at which voltage is applied to the piezoelectric element. Note, however, that the present embodiment will be described while ignoring this delay component.

In the drive signal with the trapezoidal waveform, the voltage of the pull component 204 is applied to the piezoelectric element to thereby cause the piezoelectric element to pull in the liquid surface 202 at the reference position 209 in the +Z direction (see FIG. 2B). This is done in order to perform ejection by efficiently utilizing force attempting to bring the pulled liquid surface 202 back to the original position. After the voltage of the pull component 204 is applied, the voltage of the first hold component 205 is held constant. Here, the liquid surface 202 starts moving in the −Z direction after reaching the pulled position 210, which is the farthest position to which the liquid surface 202 is pulled in in the +Z direction. Then, the voltage of the push component 206 is applied, so that the piezoelectric element pushes the liquid surface 202 all the way in the −Z direction. By the pushing force from the piezoelectric element, the resin 114 is pushed outward from the nozzle 201 and forms a liquid column. Then, the resin 114 gets separated from the liquid column by its own surface tension into the droplet 203, and lands on a region on the substrate 111.

hereafter, the voltage of the second hold component 207 is applied to the piezoelectric element. While this voltage is applied, the movement direction of the liquid surface 202 switches from the −Z direction to the +Z direction. Subsequently, the voltage of the return component 208 is applied to the piezoelectric element. This voltage serves to bring the liquid surface position back to the initial position in order to maintain continuity for repetition of the waveform, but its impact on the liquid surface 202 is small since the amount of change in voltage is small as compared to those by the other components. Thereafter, the liquid surface 202 restores itself toward its original state while repetitively vibrating in the Z direction, and returns to the reference position 209 at T6. After the droplet 203 is ejected through a series of processes as described above, similar processes are repeated again to form droplets 203 successively.

Note that the time taken by the liquid surface position to be restored to the reference position after the application of a single drive signal (the time period from T5 to T6) is determined by a composite component containing the short-lasting component shown (return component 208) and a long-lasting component not shown. For this reason, if the next drive signal is inputted in the time period from T5 to T6, a phenomenon called crosstalk occurs in which the liquid surface 202 is brought into the next ejection operation before returning to the reference position 209. In a case where the interval at which the droplets 203 are ejected is long, the occurrence of the crosstalk does not have an impact on the liquid surface return time or may have an impact but the level of the impact is negligibly low. However, in a case where the ejection interval is short, ejection has to be performed in a state where the change in the liquid surface position by the operation of ejecting the last droplet 203 still has an impact. Thus, the impact from the ejection of the last droplet changes the ejection speed and the ejection volume of the next droplet 203. The change in the ejection speed and the ejection volume appears as the difference to be handled in the later-described drive signal waveform adjustment.

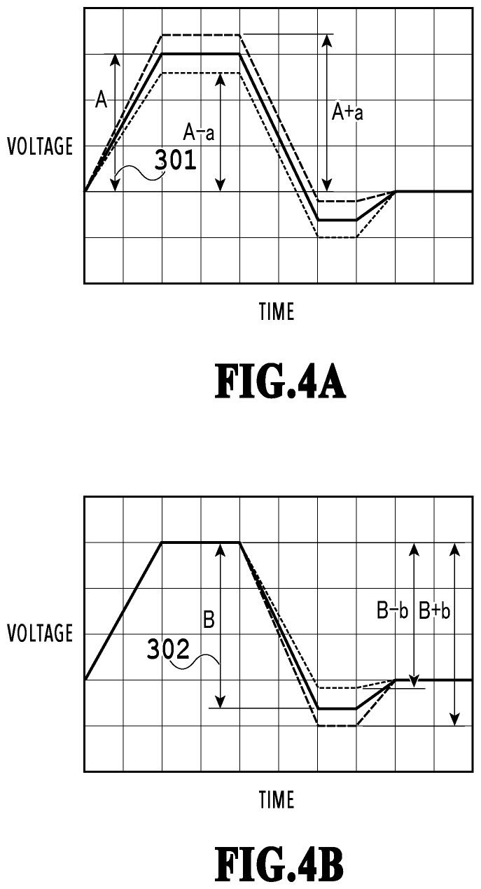

Next, an adjustment table used in the present embodiment will be described by using FIG. 4. An adjustment table 313 is obtained by recording and grouping measured values of the ejection volume and the ejection speed of the resin 114 ejected from each nozzle after at least one of the time component and the voltage component forming the waveform of the corresponding drive signal 220 is changed. This adjustment table 313 is a first table serving as a reference and generated at an initial stage before the shipment of the ejection unit. In this section, an adjustment table to be used for driving one nozzle 201 among the plurality of nozzles provided in the ejection unit 105 will be described as an example.

In this example, the above-mentioned drive signal 220 with a trapezoidal waveform is used, and two parameters to be used for the adjustment are selected. One of the parameters is a voltage component being the pull component 204 for pulling in the resin 114 in the nozzle in the +Z direction as shown in part (b) of FIG. 3, and this will be referred to as a first parameter 301. The other one of the parameters is a voltage component being the push component 206 for pushing the resin 114 in the nozzle 201 in the −Z direction as shown in part (b) of FIG. 3, and this will be referred to as a second parameter 302.

FIG. 4A is a diagram showing states where the first parameter 301 of the drive signal 220 to be used to drive the nozzle 201 (drive the piezoelectric element) is changed, and the horizontal axis represents time while the vertical axis represents voltage. The solid line in the diagram indicates the voltage waveform of a reference drive signal for the voltage to be adjusted. Assume that the value of the first parameter 301 of this reference drive signal is A. Also, a long-dashed line in the diagram indicates the voltage waveform of a drive signal obtained by making the value of the first parameter larger than A by a (A+a), and a short-dashed line indicates the voltage waveform of a drive signal obtained by making the value of the first parameter smaller than A by a (A−a).

FIG. 4B is a diagram showing states where the second parameter 302 of the drive signal 220 to be used to drive the nozzle 201 is changed, and the horizontal axis represents time while the vertical axis represents voltage. The solid line in the diagram indicates the voltage waveform of the reference drive signal, and the value of its second parameter 302 is set at B. A long-dashed line in the diagram indicates the waveform of a drive signal obtained by making the value of the second parameter larger than B by b (B+b), and a short-dashed line indicates the waveform of a drive signal obtained by making the value of the second parameter smaller than B by b (B−b).

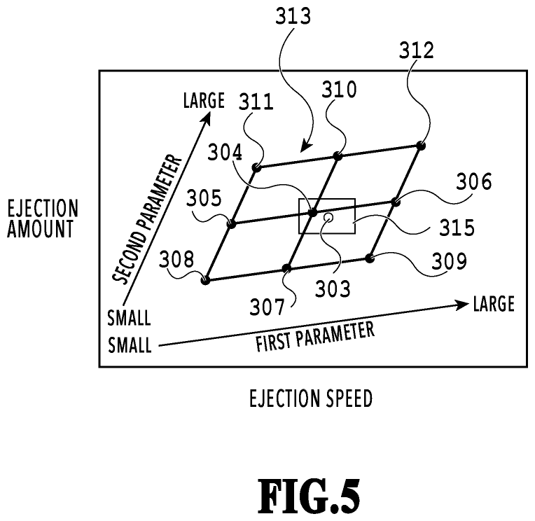

FIG. 5 is a diagram showing the ejection speeds and the ejection volumes of droplets 203 ejected from the nozzle 201 after the first parameter 301 and the second parameter 302 of the drive signal 220 are changed. In the diagram, the horizontal axis represents the ejection speed while the vertical axis represents the ejection volume.

The nozzle 201 is required to have such ejection performance as to eject a droplet 203 with a target value 303 including a target ejection speed S_{g} and a target ejection volume V_{g}. For this target value 303, a predetermined range of errors is allowed in each the ejection volume and the ejection speed in view of product specifications. These allowable error ranges are shown as a target range 315 in the diagram. Here, in a case where the allowable range of the ejection speed is ±s, for example, the product specifications are met if the ejection speed is in the range of S_{g}−s to S_{g}+s. Also, in a case where the allowable range of the ejection volume is V±v, the specifications are met if the ejection volume is in the range of V_{g}−v to V_{g}+v.

Thus, the waveform of the drive signal 220 to be applied to the piezoelectric element of the nozzle 201 is adjusted such that the ejection volume and the ejection speed fall within the respective allowable error ranges mentioned above. In the present embodiment, a measured value 304 of the ejection volume and the ejection speed of the nozzle 201 falls within the target range 315 in a case where a drive signal 220 having a waveform with the first parameter 301 set at A and the second parameter 302 set at B is applied to the piezoelectric element of the nozzle. Note that the same applies to the nozzles other than the nozzle 201. The measured values 304 of the ejection volumes and the ejection speeds of the plurality of nozzles provided in the ejection unit 105 are all adjusted to fall within the target range 315.

The dots shown in FIG. 5 represent the measured values of the ejection volume and the ejection speed of droplets 203 ejected from the nozzle 201 after the first parameter 301 and the second parameter 302 are changed. In the present embodiment, for the first parameter, the reference value is A and the adjustment range is ±a, and three values of A, A−a, and A+a are used as the first parameter for measurement. Likewise, for the second parameter, the reference value is B and the adjustment range is ±b, and three values of B, B−b, and B+b are used for measurement. Thus, in measurement of the ejection volume and the ejection speed of the nozzle 201, nine types of drive signals 220 in total are generated by combining the three first parameters and the three second parameters, and each drive signal is applied to the nozzle 201 to measure the resultant ejection speed and ejection volume.

A measured value 305 shown in FIG. 5 is the measured value in a case where the first parameter is set at A−a and the second parameter is set at B. A measured value 306 is the measured value in a case where the first parameter is set at A+a and the second parameter is set at B. A measured value 307 is the measured value in a case where the first parameter is set at A and the second parameter is set at B−b. A measured value 308 is the measured value in a case where the first parameter is set at A−a and the second parameter is set at B−b. A measured value 309 is the measured value in a case where the first parameter is set at A+a and the second parameter is set at B−b. A measured value 310 is the measured value in a case where the first parameter is set at A and the second parameter is set at B+b. A measured value 311 is the measured value in a case where the first parameter is set at A−a and the second parameter is set at B+b. A measured value 312 is the measured value in a case where the first parameter is set at A+a and the second parameter is set at B+b.

Decreasing the first parameter 301 and the second parameter 302 decreases the ejection speed and the ejection volume of the droplet 203 from the nozzle. Increasing the first parameter 301 and the second parameter 302 increases the ejection speed and ejection volume of the droplet 203 from the nozzle. By providing a graph showing the ejection speeds and ejection volumes in FIG. 5 with an axis 601 of the first parameter 301 and an axis 602 of the second parameter 302, it is possible to visualize how the ejection speed and ejection volume changes in response to a change in the later-described adjustment table for adjusting the waveform of the drive signal. The amount of change in each of ejection speed and ejection volume in response to a change in a parameter varies by how much the parameter is changed. Thus, by changing the combination of the value of the first parameter and the value of the second parameter, each of the ejection speed and the ejection volume can be changed by a desired amount. The adjustment table 313 is a group of amounts of change in the parameters and measured values of the ejection speed and the ejection volume corresponding to these with the waveform of the drive signal 220 with the measure value 304 as an origin.

The tendency of this adjustment table 313 varies by the selected parameters. Thus, in the selection of parameters, it is important to figure out in advance how the ejection speed and ejection volume change after a change is made and to select parameters with which it is easy to make an adjustment. Note that in the selection of the parameters to be used for the waveform adjustment, it is preferable to select such parameters that the ejection speed and the ejection volume change linearly in response to changes in the values of the parameters. This is because the adjustment uses an approximation of measured values, and thus using parameters that cause a linear change can improve the prediction accuracy.

Note that, in the present embodiment, amounts of change in the parameters and measured values corresponding to them are recorded individually to generate the adjustment table 313. However, the amount of change in each of ejection speed and ejection volume for the amount of change in each parameter can be defined as sensitivity, and this sensitivity can be used as an adjustment parameter. Also, various parameters may be prepared to enable various changes in ejection speed or ejection volume for the amount of change in each parameter. In the present embodiment, an example using two parameters is shown for a simple description. Increasing the types of parameters improves the ease of adjustment of the drive signal 220. Also, in a case where the ejection speed and the ejection volume can be adjusted with only one parameter, it is preferable not to use a plurality of parameters but to use only one parameter and change it since this can minimize the change in shape of the drive signal 220.

In general, the adjustment table 313 is generated before the shipment of the ejection unit 105. In the generation of the adjustment table 313, the ejection speed and the ejection volume are measured using a dedicated adjustment device provided as a separate part from the body part of the imprint apparatus 101. Note that the adjustment table generation step can be executed as long as the ejection speed and the ejection volume can be measured. Thus, the adjustment table may be generated after the ejection unit 105 is mounted in the imprint apparatus 101 by measuring the ejection speed and the ejection volume with the obtaining unit 122. This adjustment table is generated for each of the plurality of nozzles provided in the ejection unit 105 and stored in the RAM of the control unit 106.

Next, a method of adjusting the waveform of the drive signal 220 by using the adjustment table 313 will be described with reference to FIG. 5. The adjustment table 313 is a record of measured values of the ejection speed and the ejection volume after the adjustment parameters are changed. In this section, assume that the waveform of the drive signal 220 has been adjusted in the last adjustment such that the measured value is 304.

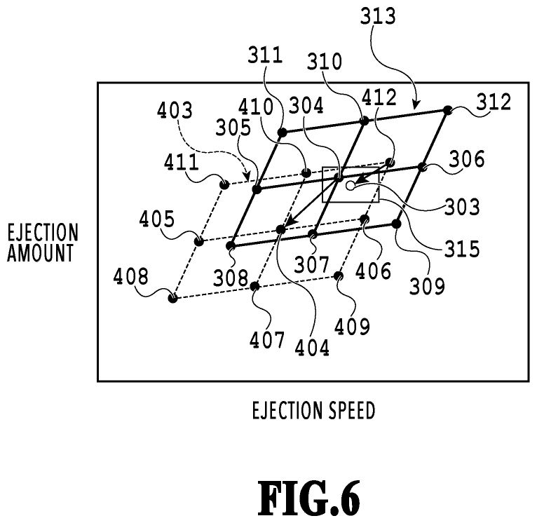

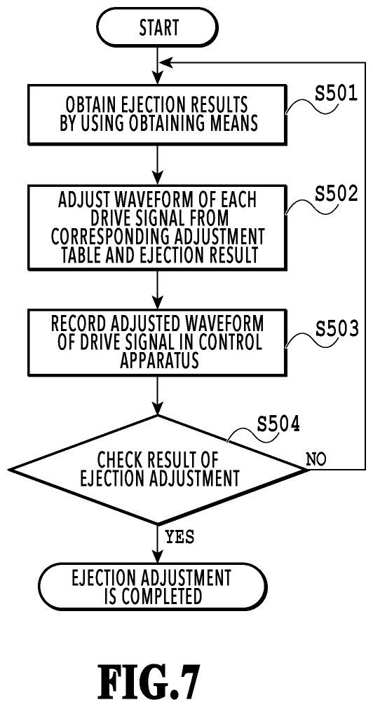

Let a measured ejection speed Sₘ and a measured ejection volume Vₘ be the ejection speed and the ejection volume, respectively, in an ejection result 404 obtained by the obtaining unit 122 in obtaining step S501 to be described later shown in a flowchart of FIG. 7. Then, the ejection result 404 can be expressed as (Sₘ, Vₘ) in a coordinate system shown in FIG. 6. Also, let S₀ and V₀ be the ejection speed and the ejection volume in the measure value 304, respectively. Then, the ejection result 304 can be expressed as (S₀, V₀) in the same coordinate system. Here, in a case where the ejection results are measured under the same condition, the measured value 304 and the ejection result 404 are supposed to match. However, even in a case where the same parameters are set, the imprint apparatus 101 may have a difference between the measured values (ejection speed and ejection volume) depending on conditions such as the distribution of heat around the ejection unit 105 and the inclination of the ejection unit 105 and the substrate 111 relative to each other. For example, even in the case where the same parameters are set, there is a possibility that the measured value 304 is offset to the measured value 404, as shown in FIG. 6. In a case where such a difference between the ejection results is defined as an ejection speed difference Sₐ and an ejection volume difference Vₐ, these differences Sₐ and Vₐ can be expressed as Sₐ=Sₘ−S₀ and Vₐ=Vₘ−V₀, respectively.

The above ejection speed difference Sₐ and ejection volume difference Vₐ are used as a shift amount (correction amount) 402 for correcting the adjustment table 313, and the correction amount 402 is used to generate a corrected adjustment table 403. Specifically, the ejection speed difference Sₐ and the ejection volume difference Vₐ are added to the ejection speed and the ejection volume, respectively, in each of the above-mentioned nine measured values, or the measured values 304, 305, 306, 307, 308, 309, 310, 311, and 312. As a result, the measured value 304 is corrected to the measured value 404, the measured value 305 is corrected to a measured value 405, the measured value 306 is corrected to a measured value 406, the measured value 307 is corrected to a measured value 407, and the measured value 308 is corrected to a measured value 408. Likewise, the measured value 309 is corrected to a measured value 409, the measured value 310 is corrected to a measured value 410, the measured value 311 is corrected to a measured value 411, and the measured value 312 is corrected to a measured value 412.

As described above, in the present embodiment, an error that occurs due to the imprint apparatus 101 similarly affects an ejection result (measured value) obtained after the drive signal 220 is changed. For this reason, the adjustment table 313, which is generated before the shipment, is corrected to generate a new corrected table 403. Note that this corrected table 403, like the table 313 before the correction, is generated for each of the plurality of nozzles provided in the ejection unit 105 and then stored in the RAM of the control unit 106.

As shown in FIG. 6, the positional relationship between the corrected adjustment table 403 and the target value 303 in the coordinate system is such that the target value 303 is surrounded by the ejection result 404 and the corrected measured values 406, 410, and 412. This indicates that a drive signal 220 with which the ejection result 404 falls inside the target range 315 can be set by changing the first parameter 301 within a section from A to A+a and changing the second parameter 302 within a section from B to B+b.

Among the measurement results, the corrected measured value 412 is the closest to the target value 303. Coordinates (SC₀, VC₀) are set as the origin for the adjustment, where SC₀ and VC₀ are the ejection speed and the ejection volume in the corrected measured value 412, respectively. The reason for selecting the closest measurement result is to reduce the later-described correction amount as much as possible. Reducing the correction amount to a small value can reduce the correction errors.

Thereafter, since the first parameter is to be changed within the section from A to A+a and the second parameter is to be changed within the section from B+b to B, the corrected measured value 410 and the corrected measured value 406 are used for the adjustment of the waveform of the drive signal. In a case of expressing the ejection speed and the ejection volume in each of the measured value 410 and the measured value 406 as coordinates, the corrected measured value 410 and the corrected measured value 406 are expressed as (SC₁, VC₁) and (SC₂, VC₂), respectively.

The amount of adjustment from the corrected measured value 412 to the target value 303 is S_{g}−SC₀ for the ejection speed and V_{g}−VC₀ for the ejection volume, and this amount of adjustment may be adjusted from the corrected measured value 412.

The amount of change in the first parameter 301 from the corrected measured value 412 to the corrected measured value 410 is −a. Thus, the amount of change in the ejection speed is (SC₁−SC₀)/−a, and the amount of change in the ejection volume is (VC₁−Vc0)/−a. Further, the amount of change in the second parameter 302 from the corrected measured value 412 to the corrected measured value 406 is −b. Thus, the amount of change in the ejection speed is (SC₂−SC₀)/−b, and the amount of change in the ejection volume is (VC₂−VC₀)/−b.

Let a1 be the amount of change in the first parameter 301 from the corrected measured value 412, and let b1 be the amount of change in the second parameter 302 from the corrected measured value 412. Then, the following holds.

$$\begin{matrix}( {SC}_{1} - {SC}_{0} ) \frac{a 1}{- a} + ( {SC}_{2} - {SC}_{0} ) \frac{b 1}{- b} = {S}_{g} - {SC}_{0} & ( Equation 1 ) \\ ( {VC}_{1} - {VC}_{0} ) \frac{a 1}{- a} + ( {VC}_{2} - {VC}_{0} ) \frac{b 1}{- b} = {V}_{g} - {VC}_{0} & ( Equation 2 )\end{matrix}$$

By calculating a1 and b1 from the above (equation 1) and (equation 2),

$$\begin{matrix}a 1 = \frac{\begin{matrix}- ( {VC}_{2} - {VC}_{0} ) ( {S}_{g} - {SC}_{0} ) + \\ ( {SC}_{2} - {SC}_{0} ) ( {V}_{g} - {VC}_{0} )\end{matrix}}{\begin{matrix}( {SC}_{1} - {SC}_{0} ) ( {VC}_{2} - {VC}_{0} ) - \\ ( {SC}_{1} - {SC}_{0} ) ( {VC}_{2} - {VC}_{0} )\end{matrix}} a & ( Equation 3 ) \\ b 1 = \frac{\begin{matrix}( {VC}_{1} - {VC}_{0} ) ( {S}_{g} - {SC}_{0} ) + \\ ( {SC}_{1} - {SC}_{0} ) ( {V}_{g} - {VC}_{0} )\end{matrix}}{\begin{matrix}( {SC}_{1} - {SC}_{0} ) ( {VC}_{2} - {VC}_{0} ) - \\ ( {SC}_{1} - {SC}_{0} ) ( {VC}_{2} - {VC}_{0} )\end{matrix}} b & ( Equation 4 )\end{matrix}$$

the above are obtained.

Since the first parameter 301 of the drive signal 220 with the corrected measured value 412 is A+a, A+a+a1 is the result of the adjustment of the first parameter 301. Likewise, since the second parameter 302 of the drive signal 220 with the corrected measured value 412 is B+b, B+b+b1 is the result of the adjustment of the second parameter 302. The waveform of the drive signal 220 is updated based on these adjustment results. The present embodiment has been described for the one nozzle 201 as an example. In practice, the adjustment table 313 generated for each nozzle is used to adjust the waveform of the corresponding drive signal 220 mentioned above. Also, in the present embodiment, the amount of change in the first parameter 301 is ±a. In addition to ±a as an amount of change, another amount of change (e.g., ±2a or the like) may be set to increase the number of measured values. The larger the number of measured values, the higher the accuracy of the above-mentioned adjustment method. Thus, it is preferable to increase the number of measured values. For the amount of change in the second parameter 301 too, it is preferable to increase the number of measured values, as with the first parameter 301.

Note that the above-described method of adjusting the parameters of the drive signal 220 is merely an example. The ejection speed and the ejection volume can be adjusted by another drive signal parameter adjustment method. Specifically, the present invention can be carried out by using another adjustment method of adjusting the ejection result 404 to the target value 303. Also, even in a case where the ejection result 404 is present in the target range 315, the waveform of the drive signal may still be adjusted to bring the ejection result 404 closer to the target value 303.

Next, an ejection adjustment method executed in the present embodiment will be described. FIG. 7 is a flowchart showing steps in the ejection adjustment in the present embodiment, and the description will be given through four separate steps S501 to S504. Note that, before entering these steps, the waveform of the drive signal to be applied to the piezoelectric element of each nozzle 201 are adjusted, and the adjustment table 313 is obtained for each nozzle and stored in the RAM of the control unit 106.

In S501, the ejection results 404 of all nozzles provided in the ejection unit 105 are obtained by using the obtaining unit 122. Specifically, the resin 114 is ejected onto the substrate 111 from each of the plurality of nozzles provided in the ejection unit 105, and the position and shape of the resin 114 ejected onto the substrate 111 are observed using the observation measurement instrument 128 to thereby obtain each ejection result 404 of the resin 114. In S502, the amount of adjustment of the ejection waveform is calculated based on this ejection result 404, and the ejection is adjusted. The CPU included in the control unit or the like is used to perform the ejection of the resin 114, the obtaining of the ejection result with the observation measurement instrument 128, and so on in S501.

Note that the obtaining unit for obtaining the ejection result 404 of the resin 114 is not limited to the one that observes the position and shape of the resin 114 ejected onto the substrate 111. In an example, a measurement device that directly measures the ejection volume and the ejection speed of a droplet 203 can be installed as obtaining unit in the imprint apparatus 101, and the result of that measurement can be used as an ejection result.

Also, in the present embodiment, an example in which the obtaining unit 122 is provided in the body of the imprint apparatus 101 has been presented. However, a measurement device provided outside the body of the apparatus can be used to measure the resin 114 applied onto the substrate 111 and obtain its ejection result. In an example, after the resin 114 applied from each nozzle onto the substrate 111 is cured, the outside measurement device may be used to measure the thickness of the resin 114 or to measure the applied position and shape of the resin 114.

Then, in S502, the waveform of each drive signal is adjusted based on the corresponding adjustment table 313 pre-stored in the RAM of the control unit 106 and the corresponding ejection result 404 obtained in S501. This adjustment is performed as follows.

First, the amount of offset between the applied position of the resin 114 ejected onto the substrate 111 in S501 and a target applied position is calculated, and the amount of adjustment in the ejection speed is calculated based on the amount of the offset. Also, the surface area of the applied resin 114 is read from the shape of that resin 114, the amount of adjustment in the ejection volume is calculated from the difference between the read surface area and a target surface area.

The first parameter 301 and the second parameter 302 of each drive signal 220 are adjusted by using the amount of adjustment in the ejection speed and the amount of adjustment in the ejection volume obtained as described above from the corresponding ejection result 404 and the corresponding adjustment table 313 stored in the RAM of the control unit 106. The adjustment method is as described above, and description thereof is omitted here.

In S503, the adjusted drive signal 220 is stored in the RAM of the control unit 106. Specifically, waveform information on the drive signal 220 recorded in the control unit 106 is updated to waveform information on the drive signal 220 obtained in S502. This change is made for all nozzles mounted in the ejection unit 105. Note that the waveform information on the drive signal 220 before the update is saved in the RAM of the control unit 106 as a record.

In S504, each ejection adjustment result is checked. As for the content to be checked, the ejection result 404 of the resin 114 ejected onto the substrate 111 from the nozzle based on the updated signal 220 is obtained, and whether the ejection result 404 is within the target range 315 is checked. The adjustment process is terminated for those nozzles 201 whose ejection results 404 are within the target range 315. For those nozzles 201 whose ejection results 404 are not within the target range 315, the ejection adjustment process is performed again in S501 to S503 to perform a re-adjustment. Then, the ejection adjustment process is completed if the waveform information on the drive signals 220 for all nozzles is updated.

As described above, in the present embodiment, each nozzle of the ejection unit 105 is provided with an adjustment table (first adjustment table) 313 for adjusting the waveform of its drive signal. Then, in a case where the ejection volume and the ejection speed of any nozzle have errors, the ejection volume and the ejection speed are corrected by determining the amount of adjustment of the drive signal waveform based on the amounts of the errors between the ejection volume and the ejection speed of the nozzle and the adjustment table 313 dedicated for the nozzle. In this manner, all nozzles provided in the ejection unit 105 can undergo accurate correction based on their respective ejection tendencies. Hence, a droplet can be ejected appropriately from each nozzle.

Also, according to the present embodiment, it is possible to handle not only ejection errors that occur due to a structural variation of the ejection unit but also ejection errors that occur after the mounting of the shipped ejection unit 105 into an imprint apparatus or the like. Examples of the ejection errors that occur with the shipped ejection unit 105 include ejection errors due to a difference between apparatuses (e.g., imprint apparatuses) in which the ejection unit is designed to be mounted, inclination of the ejection unit 105 and the substrate 111 relative to each other, and a difference in distribution of heat around the ejection unit. In a case where such an ejection error occurs, a new adjustment table (second adjustment table) is generated for each nozzle by correcting its first adjustment table, which serves as a reference, as mentioned above, and the ejection error of each nozzle is adjusted based on its second adjustment table. In this manner, it is possible to accurately maintain the ejection accuracy of each nozzle in the ejection unit 105.

### Other Embodiments

The present invention is not limited to the above embodiment, but various modifications and changes can be made without departing from the gist of the present invention.

For instance, the waveform of the drive signal 220 shown in the present embodiment is a mere example. Even with a waveform different from this waveform, an adjustment table can still be generated as long as the ejection volume and the ejection speed after a change in the parameters are figured out. Thus, the present invention can be implemented by providing a table other than the above-described adjustment table for each nozzle.

Also, in the above embodiment, an example has been presented in which two parameters (first parameter and second parameter) are used to determine the waveform of the drive signal to be applied to the ejection energy generation element. However, the number of parameters that determine the waveform of the drive signal may be one or three or more, and an adjustment table may be generated for each nozzle based on such a parameter(s) used. In this manner, it is possible to accurately adjust the ejection speed and the ejection volume of a droplet to be ejected from each nozzle based on a plurality of adjustment parameters.

Further, the timing of application of the drive signal to the piezoelectric element (ejection energy generation element) can be included as a parameter that determines the waveform of the drive signal. In this way, it is also possible to change the timing of ejection of a droplet from each nozzle. In the imprint apparatus 101, the resin 114 (droplets 203) ejected from the ejection unit 105 toward the substrate 111 on the substrate stage 104 moving relative to the ejection unit 105 to apply the resin onto the substrate 111. For this reason, by changing the timing of ejection of a droplet from each nozzle with a parameter, it is possible to change the applied position in the movement direction of the substrate stage 104. In this way, it is possible to change the ejection speed of the droplet to be ejected from each nozzle without changing its ejection volume. A time T by which to change the ejection timing can be calculated by T=X/Ss, where X is the amount of adjustment in the movement direction of the substrate stage 104, and Ss is the movement speed of the substrate stage 104.

The present invention can be implemented with a process involving: supplying a program that implements one or more of the functions in the above embodiments to a system or an apparatus through a network or a storage medium; and causing one or more processors in a computer in the system or the apparatus to read out and execute the program. Also, the present invention can be implemented with a circuit that implements one or more of the functions (e.g., ASIC).

While the present invention has been described with reference to embodiments, it is needless to say that the present invention is not limited to the above embodiments. The scope of the following claims is to be accorded the broadest interpretation so as to encompass all such modifications and equivalent structures and functions.

1. An ejection apparatus characterized in that the ejection apparatus comprises:
ejection unit having a plurality of nozzles for ejecting a fluid in a liquid state;
control unit configured to control ejection of the fluid from each of the plurality of nozzles by applying a drive signal to an ejection energy generation element included in the nozzle;
obtaining unit configured to obtain an ejection result of the fluid ejected from the nozzle; and
storage unit configured to store an adjustment table for adjustment of the drive signal for each of the plurality of nozzles, the adjustment table indicating a relationship between waveform information on the drive signal for each of the nozzles and an ejection volume and ejection speed of the fluid ejected from the nozzle,
wherein the control unit adjusts ejection from each of the nozzles based on the corresponding adjustment table and the corresponding ejection result obtained by the obtaining unit.

2. The ejection apparatus according to claim 1, wherein
the obtaining unit obtains ejection volumes and ejection speeds of the fluid ejected from the nozzle as a result of applying a plurality of the drive signals with different waveforms to the ejection energy generation element, and
the adjustment table is generated by using a plurality of the ejection results obtained by the obtaining unit.

3. The ejection apparatus according to claim 2, wherein
the adjustment table includes a first table generated at an initial stage and a second table generated by correcting the first table,
the second table is a table generated by correcting the first table by using an ejection result of the fluid ejected from the corresponding nozzle under a condition different from a condition at the initial stage.

4. The ejection apparatus according to claim 1, wherein the waveform information contains a voltage component and a time component that determine a shape of a waveform of the drive signal.

5. The ejection apparatus according to claim 4, wherein the time component includes a timing for application of the drive signal to the ejection energy generation element.

6. The ejection apparatus according to claim 1, wherein
the ejection energy generation element is a piezoelectric element, and
the waveform information includes a first parameter representing a voltage component and a time component that drive the piezoelectric element so as to pull in the fluid filled in the nozzle, and a second parameter representing a voltage component and a time component that drive the piezoelectric element so as to eject the fluid present in the nozzle to an outside of the nozzle.

7. The ejection apparatus according to claim 1, wherein the ejection result is information indicating at least one of a position, a shape, and a thickness of the fluid applied from the nozzle onto a predetermined ejection target object.

8. An ejection method of ejecting a fluid in a liquid state from each of a plurality of nozzles for ejecting the fluid by applying a drive signal to an ejection energy generation element included in the nozzle, characterized in that the ejection method comprises:
preparing an adjustment table for adjustment of the drive signal for each of the nozzles;
obtaining an ejection result of the fluid ejected from the nozzle;
storing the adjustment table for adjustment of the drive signal for each of the plurality of nozzles, the adjustment table indicating a relationship between waveform information on the drive signal for each of the nozzles and an ejection volume and ejection speed of the fluid ejected from the nozzle; and
adjusting ejection from each of the nozzles based on the corresponding adjustment table and the corresponding ejection result obtained by the obtaining.

9. An article manufacturing apparatus that ejects a fluid in a liquid state onto a predetermined ejection target object from a plurality of nozzles provided in ejection unit, and pressing a mold against the fluid ejected onto the ejection target object to thereby form a pattern in the fluid, characterized in that the article manufacturing apparatus comprises:
control unit configured to control ejection of the fluid from each of the plurality of nozzles by applying a drive signal to an ejection energy generation element included in the nozzle;
obtaining unit configured to obtain an ejection result of the fluid ejected from the nozzle; and
storage unit configured to store an adjustment table for adjustment of the drive signal for each of the plurality of nozzles, the adjustment table indicating a relationship between waveform information on the drive signal for each of the nozzles and an ejection volume and ejection speed of the fluid ejected from the nozzle,
wherein the control unit adjusts ejection from each of the nozzles based on the corresponding adjustment table and the corresponding ejection result obtained by the obtaining unit.

10. The article manufacturing apparatus according to claim 9, wherein the adjustment table is generated based on an ejection result measured outside the manufacturing apparatus.

11. A non-transitory computer readable storage medium storing a program which causes a computer to perform an ejection method of ejecting a fluid in a liquid state from each of a plurality of nozzles for ejecting the fluid by applying a drive signal to an ejection energy generation element included in the nozzle, characterized in that the ejection method comprises:
preparing an adjustment table for adjustment of the drive signal for each of the nozzles;
obtaining an ejection result of the fluid ejected from the nozzle;
storing the adjustment table for adjustment of the drive signal for each of the plurality of nozzles, the adjustment table indicating a relationship between waveform information on the drive signal for each of the nozzles and an ejection volume and ejection speed of the fluid ejected from the nozzle; and
adjusting ejection from each of the nozzles based on the corresponding adjustment table and the corresponding ejection result obtained by the obtaining.
